(19) United States
(12) Patent Application Publication
(10) Pub. No.: US 2021/0235607 A1
(43) Pub. Date: Aug. 5, 2021

(54) PLANT WEEDING DEVICE

(71) Applicant: SEOUNG JUN LEE, GYEONGGI-DO (KR)

(72) Inventor: SEOUNG JUN LEE, GYEONGGI-DO (KR)

(21) Appl. No.: 17/051,609

(22) PCT Filed: Jul. 30, 2019
(86) PCT No.: PCT/KR2019/009475

§ 371 Date: Oct. 29, 2020

(30) Foreign Application Priority Data
Aug. 3, 2018 (KR) 10-2018-0090848
May 30, 2019 (KR) 10-2019-0063733
Jun. 19, 2019 (KR) 10-2019-0072826

(51) Int. Cl. A01B 1/16; A01M 21/02

(52) U.S. Cl. CPC A01B 1/16; A01M 21/02

(57) ABSTRACT

A plant weeding device according to the present invention includes: a housing having a coupling hole penetrating a center of the housing; a rod penetrating the coupling hole and configured to be resiliently movable and rotatable; a weeding blade coupled to one end of the rod and configured to cooperatively rotate and dig up the soil to remove weeds from plants; and a power means configured to be coupled to or separated from the other end of the rod and configured to rotate the rod.

### TECHNICAL FIELD

The present invention relates to a plant weeding device, and more particularly, to a plant weeding device capable of completely removing weeds by removing even the roots of the weeds in the soil.

### BACKGROUND ART

Typically, most farmers directly grasp and use agricultural tools such as shovels, hoes, and hooks to manually perform weeding operations to remove weeds.

Because farmers manually remove weeds by directly holding agricultural tools and squatting or standing on the ground, which applies loads to the farmer's knees and waists, it is difficult to perform the weeding operations, and thus the farmers tend to avoid the weeding operation.

In particular, because there are many difficulties in cultivating crops due to the aging of the agricultural population and the shortage of manpower in rural areas, a method of solving these difficulties is required.

The typical weeding operations mainly include a method of manually picking and removing the weeds one by one or a method of cutting and removing the weeds by using a sickle or a lawnmower. However, there is a limitation in that a large amount of cost and time are required to perform the weeding operation and an effect of maintaining the state in which the weeds are removed deteriorates because the weeds regrow within a short time.

Further, as a weeding method of consistently maintaining the state in which the weeds are removed, there is a method of spraying herbicide. However, this method has a fatal drawback in that toxicity of the herbicide persists for a long time, which adversely affects the ecosystem and results in a risk of harming the health of workers.

Accordingly, recently, Korean Patent No. 10-0731681 discloses a method and a device for removing weeds by using steam as a method of solving the problems with the weeding operation in the related art.

As illustrated in FIG. 1, according to the method and the device for removing weeds by using steam, an upper portion of a weed is covered by a pressing plate 10, an inner space 14 of the pressing plate is filled with heat of the steam generated by a weed remover 40 through a heat source supply line 30, and then the heat of the steam is evenly released through a nozzle hole 11 to remove the weed. In this case, the heat of the steam is 120° C. to 170° C. in accordance with types of weeds, and the release of the heat continues for 30 seconds to 1 to 2 minutes in accordance with types and thicknesses of weeds.

However, the method and the device for removing weeds by using steam cannot be practically applied because the pressing plate 10 needs to stay at a specific position in order to remove weeds, which causes an excessive increase in working time and results in work efficiency lower than work efficiency of the manual weeding operation. In addition, there is a disadvantage in that there is a high risk of thermal damage and burns to peripheral animals and plants due to the steam leaking to the periphery of the pressing plate during a process of supplying the steam over a long time, and the steam is excessively consumed, which causes an increase in operating costs.

### DISCLOSURE

### Technical Problem

In order to solve the above-mentioned problems, the present invention provides a plant weeding device capable of completely removing weeds by removing even the roots of the weeds in the soil.

In addition, another object of the present invention is to provide a plant weeding device having a small volume and weight, such that the plant weeding device is easy to carry and store and allows a user to perform work while standing, thereby ensuring convenience and stability.

In addition, still another object of the present invention is to provide a plant weeding device to which rotational force is provided to enable a power means to be attached and detached, such that the power means such as a drilling machine commonly existing at home or industrial sites may be used.

In addition, yet another object of the present invention is to provide a plant weeding device having a grasping means that penetrates into the soil to constitute a support for supporting a cutting edge without swaying even though resistive force is generated when the cutting edge is rotated by a drive means and digs up the soil, in which the grasping means is returned to above the ground surface by a spring, thereby providing work convenience.

In addition, still yet another object of the present invention is to provide a plant weeding device having a rod and a weeding blade that may be coupled or separated in one-touch manner and thus easily replaced, thereby improving maintenance characteristics and operational characteristics of the weeding device.

### Technical Solution

In order to achieve the above-mentioned objects, a plant weeding device according to the present invention includes: a housing having a coupling hole penetrating a center of the housing; a rod penetrating the coupling hole and configured to be resiliently movable and rotatable; a weeding blade coupled to one end of the rod and configured to cooperatively rotate and dig up the soil to remove weeds from plants; a power means configured to be coupled to or separated from the other end of the rod and configured to rotate the rod; and a grasping means installed around one end of the housing and configured to penetrate into the soil to support the rotation of the weeding blade.

According to the present invention, an elastic member is installed at an outer circumferential edge of the rod penetrating the coupling hole in the housing, the elastic member is installed between a first stepped member installed at one side of the coupling hole and a second stepped member installed at the other side of the coupling hole, and the elastic member is compressed by the first stepped member that operates in conjunction with the movement of the rod.

According to the present invention, an installation hole is formed at an end of the rod, and a fixing ball is received in a mounting hole formed at an outer circumferential edge of the rod, such that the fixing ball is selectively and partially exposed to the inside of the installation hole, in which a holder is provided to be movably coupled to an outer circumferential edge of the rod, and the holder is resiliently moved by a spring installed in the holder, in which a state in which the fixing ball is exposed to the installation hole through an introduction hole having multiple steps having different diameters at an inner circumferential edge of the holder is determined depending on a state in which the holder moves, in which when an end protruding from the weeding blade is coupled into the installation hole, the fixing ball is received in an inwardly recessed groove formed at an outer circumferential edge of the end, and the fixing ball is received in a portion of the introduction hole having the multiple steps, which has a relatively small diameter, in order to secure a coupled state between the rod and the weeding blade, and in which when the holder moves while compressing the spring, the fixing ball is moved to a portion of the introduction hole, which has a relatively large diameter, and the fixing ball is withdrawn from an inwardly recessed groove at the end, such that the weeding blade is uncoupled from the rod.

According to the present invention, an installation hole is formed at an end of the rod, and a recess is formed at an inlet end of the installation hole and receives a fixing ball supported by a snap ring, in which a second end at an end protruding frm the weeding blade is coupled into the installation hole, and the fixing ball is partially received in an inwardly recessed groove formed at an outer circumferential edge of the end, and in which the received state is maintained by the snap ring in order to secure a coupled state between the rod and the weeding blade.

According to the present invention, an installation hole and a communication hole are formed at an end of the rod so as to form multiple steps having different diameters, and a connecting hole is formed at an outer circumferential edge of the rod while traversing the communication hole, and in which when a first end and a second end, which protrude from the weeding blade and have multiple steps therebetween, are coupled to the installation hole and the communication hole, a catching hole formed at the second end and the connecting hole communicate with each other, and a catching member is coupled to couple the weeding blade to the rod.

According to the present invention, an inlet hole and a catching groove are formed at one end of the rod so as to communicate with each other and have multiple steps therebetween, and a communication hole is formed in the rod so as to communicate with the catching groove, in which a plurality of cut-out holes is formed at an outer circumferential edge of the rod and disposed at an equal interval so as to communicate with the communication hole so that the catching groove is resiliently enlarged, such that a catching end, which is formed integrally with the weeding blade through a first end, is coupled to the catching groove through the inlet hole in a catching manner, in which an installation hole is formed in a protruding portion formed on a bottom surface of the installation hole so that a second end formed at a rear side of the catching end of the weeding blade is coupled to the installation hole, in which enlargement holes are formed at ends of the cut-out holes, a withdrawal hole is formed at an outer circumferential edge of the protruding portion so as to communicate with the bottom surface of the installation hole, such that the second end of the weeding blade is exposed through the withdrawal hole, and in which the weeding blade is separated from the installation hole by inserting a pointy tool into the withdrawal hole.

According to the present invention, an installation hole is formed at an end of the rod, a mounting hole is formed at an outer circumferential edge of the rod, and a fixing ball is inserted into the mounting hole, in which a first end, an inwardly recessed groove, and a second end are sequentially formed on the weeding blade, in which the inwardly recessed groove having a semicircular shape communicates with the mounting hole, the fixing ball is coupled to the inwardly recessed groove to maintain a coupled state between the weeding blade and the rod, and the second end is coupled to the installation hole in order to prevent idling, and in which a binding means is coupled to a binding groove formed at the outer circumferential edge of the rod in order to prevent the fixing ball from being withdrawn from the mounting hole.

### Advantageous Effects

As described above, the plant weeding device according to the present invention includes: a housing having a coupling hole penetrating a center of the housing; a rod penetrating the coupling hole and configured to be resiliently movable and rotatable; a weeding blade coupled to one end of the rod and configured to cooperatively rotate and dig up the soil to remove weeds from plants; a power means configured to be coupled to or separated from the other end of the rod and configured to rotate the rod; and a grasping means installed around one end of the housing and configured to penetrate into the soil to support the rotation of the weeding blade.

Therefore, even the roots of the weeds in the soil are removed so that the weeds are completely removed, thereby improving weed removing efficiency.

In addition, the plant weeding device according to the present invention has a small volume and weight and thus is easy to carry and store.

In particular, the plant weeding device enables a user to simply remove, while standing, weeds inhabiting in grassplots such as weekend farms, gardens of rural houses, lawns, parks, playgrounds, golf courses, graveyards, and the like. Further, the plant weeding device cuts the roots without pulling out or digging up the roots of the weeds and thus has an advantage in that it is not necessary to collect residues after removing the weeds.

In addition, rotational force is provided to the plant weeding device according to the present invention in order to enable the power means to be attached and detached, and a drilling machine commonly existing at home or industrial sites may be used as the power means, thereby providing convenience of use.

In addition, according to the plant weeding device according to the present invention, even though the resistive force is generated as the cutting edge is rotated by the drive means and digs up the soil, the cutting edge may be supported without swaying because the grasping means penetrate into the soil, such that effective weeding efficiency of the cutting edge is improved.

In addition, according to the plant weeding device according to the present invention, the rod and the weeding blade may be coupled or separated in one-touch manner and thus easily replaced, thereby improving maintenance characteristics and operational characteristics of the weeding device.

### DESCRIPTION OF DRAWINGS

FIG. 1 is a perspective view illustrating a plant weeding device according to the present invention.

FIG. 2 is a partially enlarged perspective view illustrating the plant weeding device according to the present invention.

FIG. 3 is a partially enlarged perspective view illustrating another exemplary embodiment of the plant weeding device according to the present invention.

FIG. 4 is a cross-sectional view illustrating a state before the plant weeding device according to the present invention operates.

FIG. 5 is a cross-sectional view illustrating a state after the plant weeding device according to the present invention operates.

FIG. 6 is a front view illustrating a state in which the plant weeding device according to the present invention operates.

FIG. 7 is a front view illustrating a state in which a grasping means of the plant weeding device according to the present invention penetrates into the soil.

FIG. 8 is a front view illustrating a state in which a cutting edge of the plant weeding device according to the present invention is used to remove weeds from plants.

FIGS. 9 to 11 are cross-sectional views illustrating states in which a rod and a holder of a plant weeding device according to a first exemplary embodiment of the present invention are coupled.

FIGS. 12 and 13 are cross-sectional views illustrating states in which the rod and a weeding blade of the plant weeding device according to the first exemplary embodiment of the present invention are coupled.

FIGS. 14 and 15 are schematic views illustrating states in which the rod and the weeding blade of the plant weeding device according to the first exemplary embodiment of the present invention are coupled.

FIGS. 16 and 17 are cross-sectional views illustrating states in which a rod and a weeding blade of a plant weeding device according to a second exemplary embodiment of the present invention are coupled.

FIGS. 18 and 19 are cross-sectional views illustrating states in which a rod and a weeding blade of a plant weeding device according to a third exemplary embodiment of the present invention are coupled.

FIGS. 20 to 22 are cross-sectional views illustrating states in which a rod and a weeding blade of a plant weeding device according to a fourth exemplary embodiment of the present invention are coupled.

FIGS. 23 and 24 are cross-sectional views illustrating states in which a rod and a weeding blade of a plant weeding device according to a fifth exemplary embodiment of the present invention are coupled.

### DESCRIPTION OF MAIN REFERENCE NUMERALS OF DRAWINGS

100: Weeding device
110: Housing
111: Coupling hole
112: Elastic member
113: First stepped member
114: Set screw
115: Second stepped member
116: Cover
118: Through hole
120: Rod
120a: Protruding portion
121: Connecting surface
122: Installation hole
122a: Catching groove
122b: Cut-out hole
122c: Enlargement hole
122d: Inlet hole
123: Mounting hole
124: Fixing ball
125: Recess
126: Snap ring
127: Second catching projection
128: Binding means
129: Binding groove
130: Weeding blade
131: Cutting surface
131a: Tip
132: End
133: First end
133a: Catching end
134: Second end
135: Inwardly recessed groove
136: Communication hole
136a: Withdrawal hole
137: Catching member
138: Connecting hole
139: Catching hole
140: Power means
150: Grasping means
151: Bent portion
152: Penetration portion
160: Holder
161: Spring
162: Introduction hole
163: First catching projection

### BEST MODE

Hereinafter, exemplary embodiments of the present invention will be described in detail with reference to the accompanying drawings.

First, it should be noted that like reference numerals indicate like constituent elements or components in the drawings wherever possible. In the description of the present invention, the specific descriptions of related well-known functions or configurations will be omitted in order not to obscure the subject matter of the present invention.

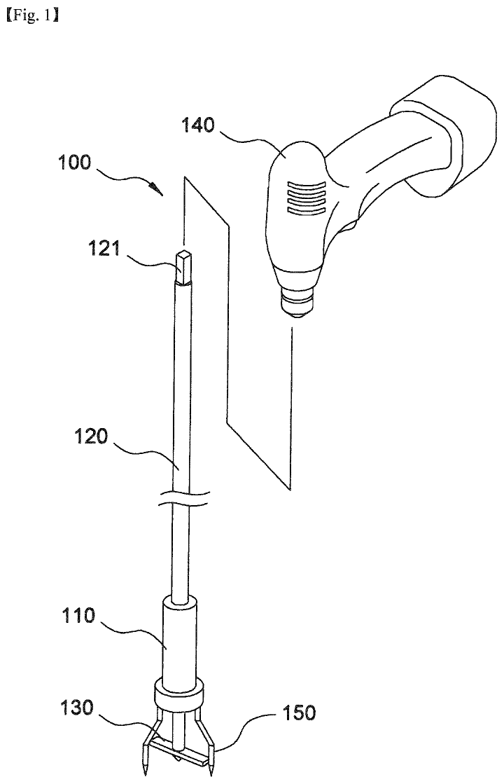

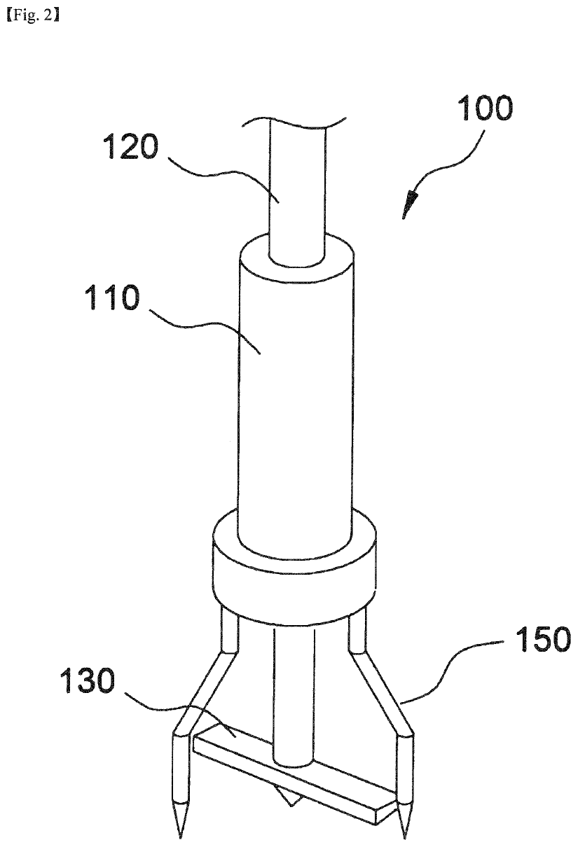

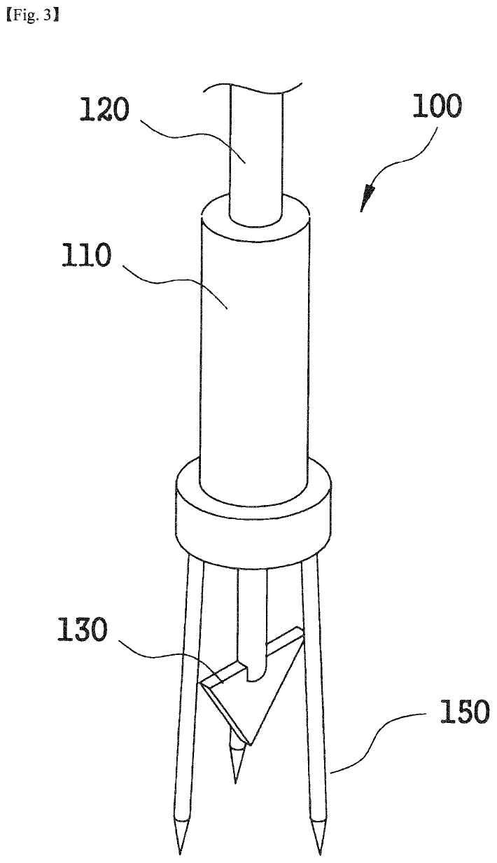

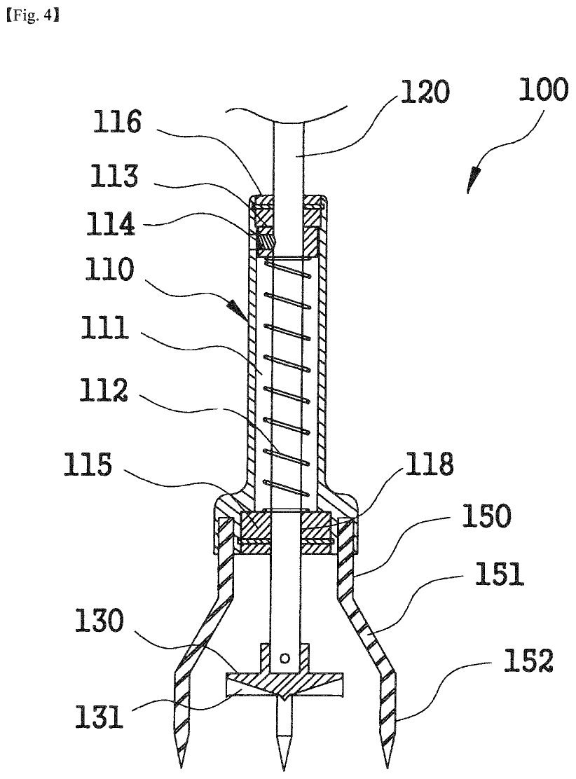

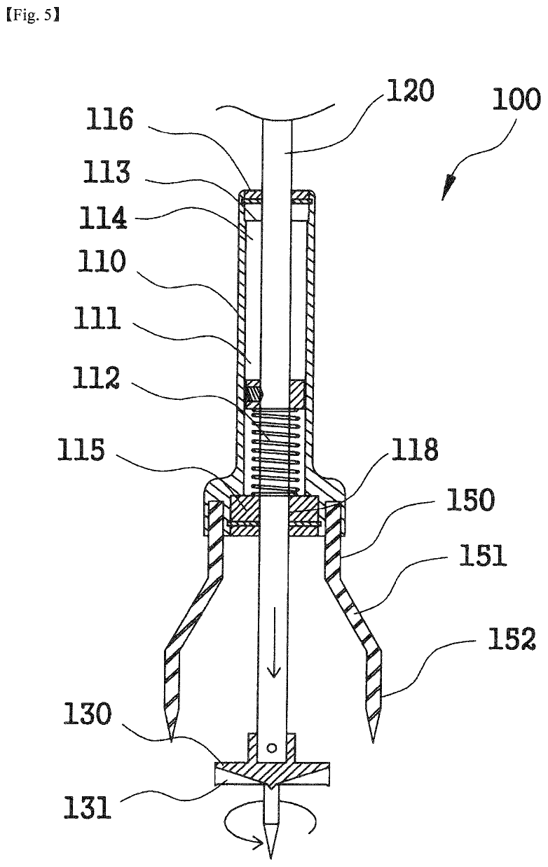

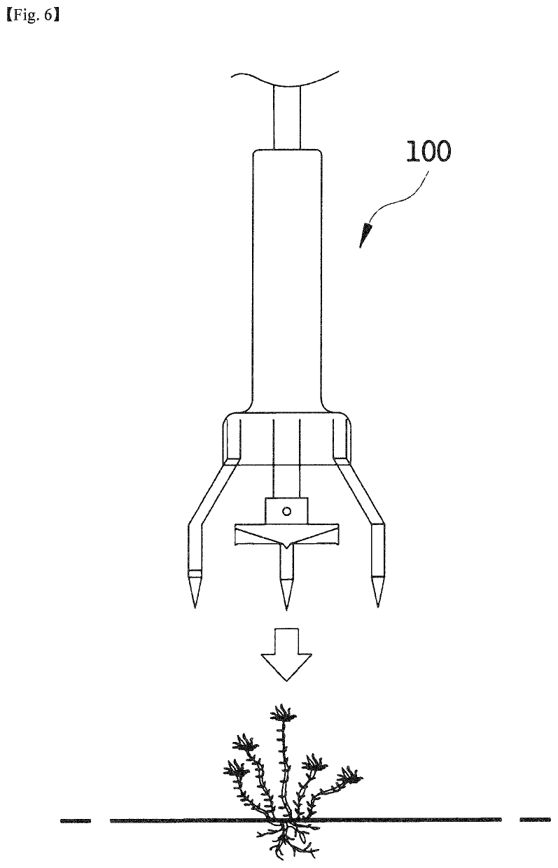

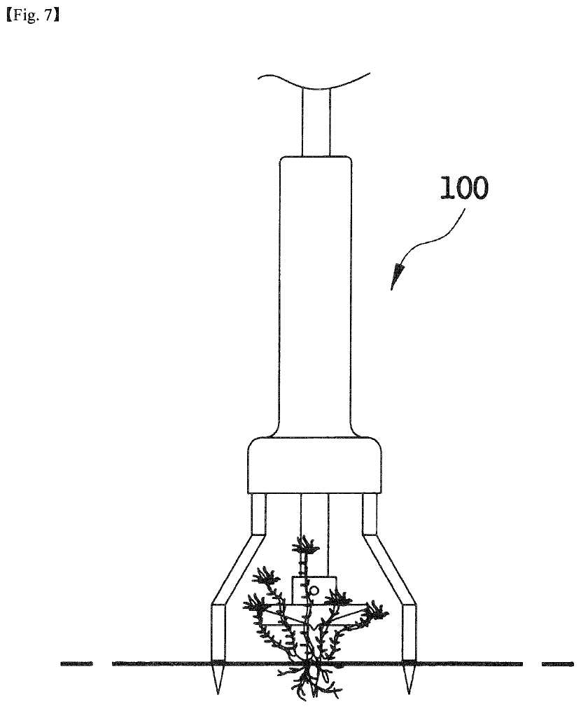

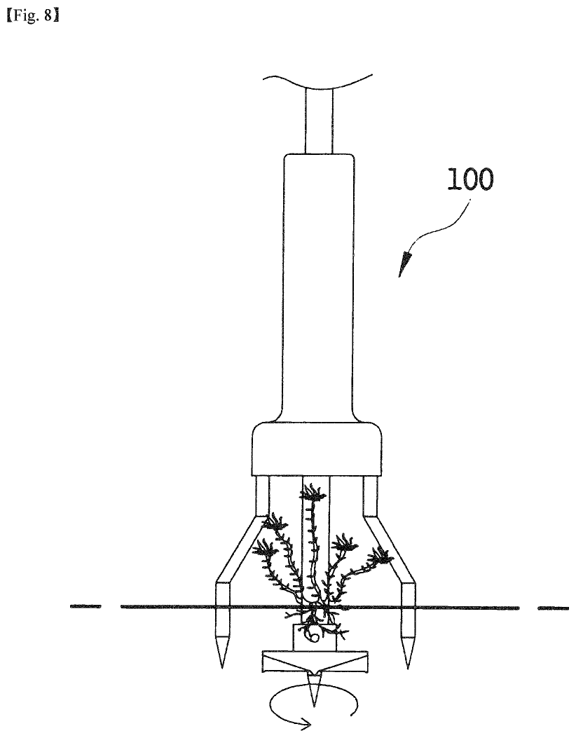

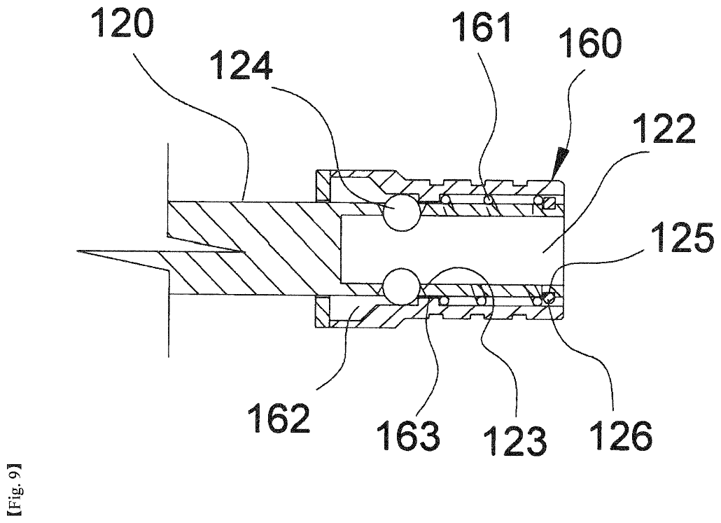

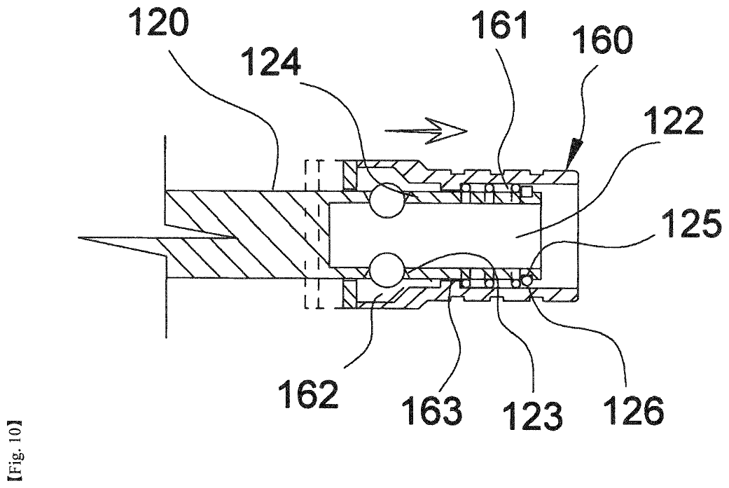

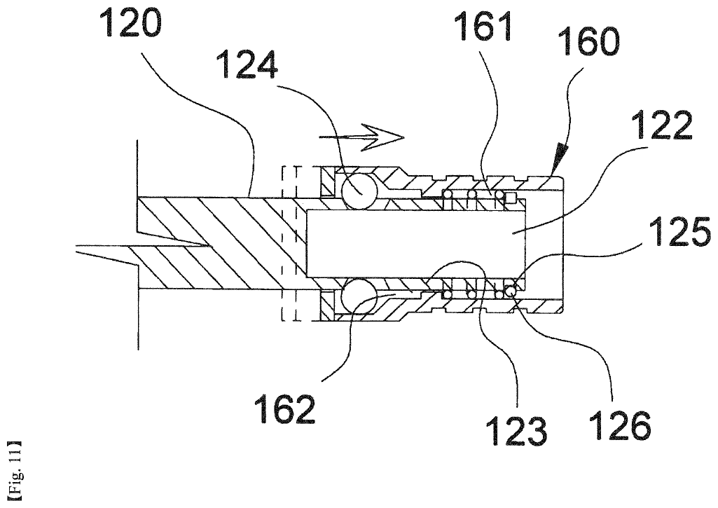

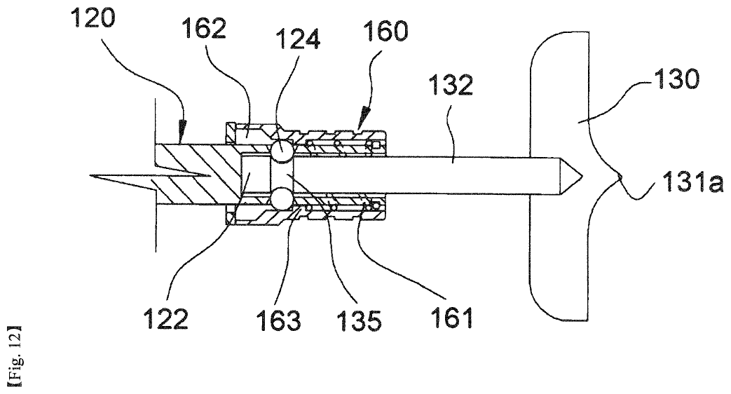

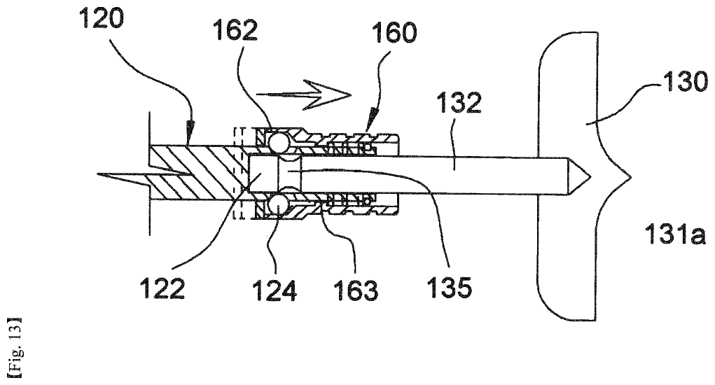

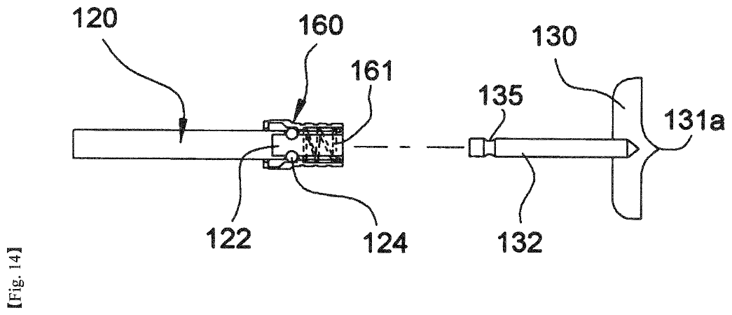

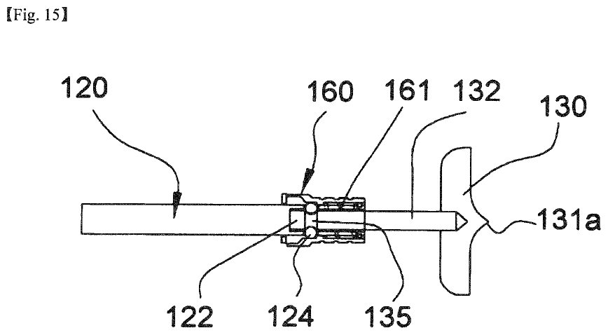

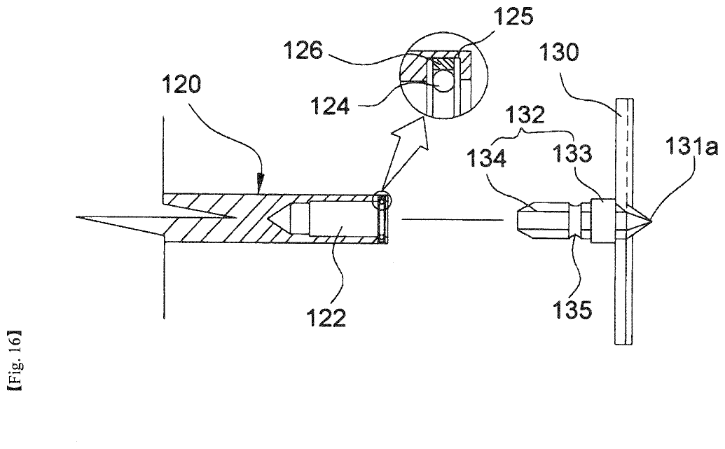

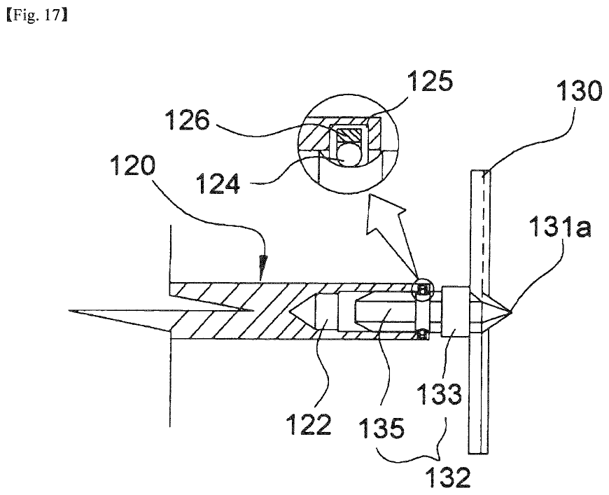

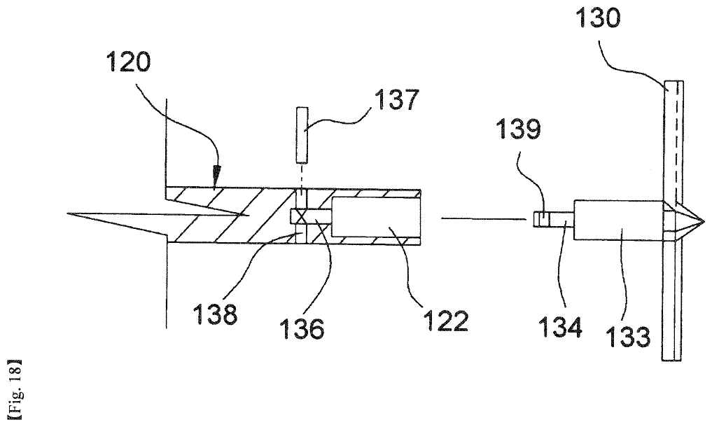

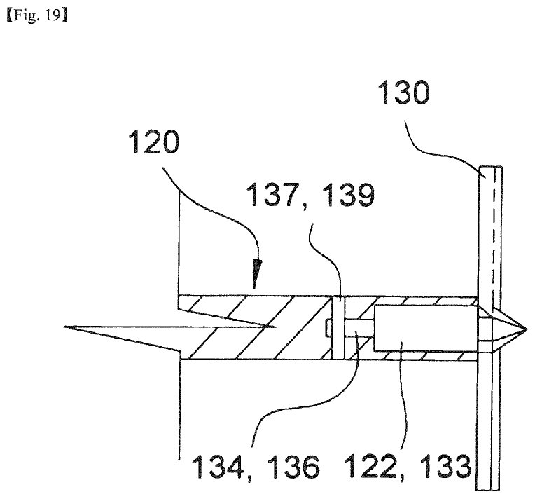

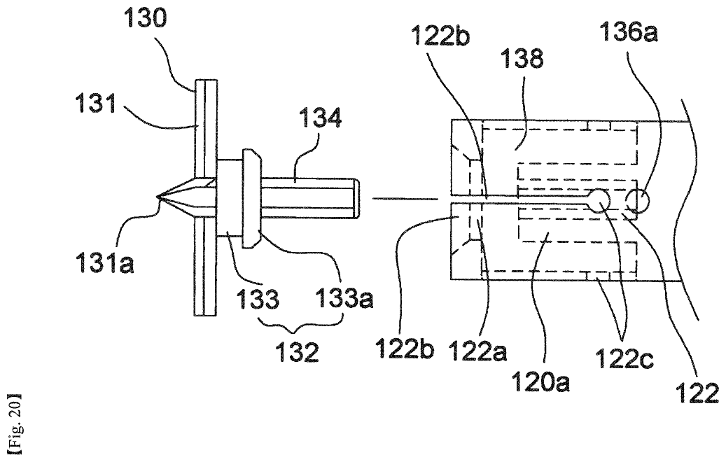

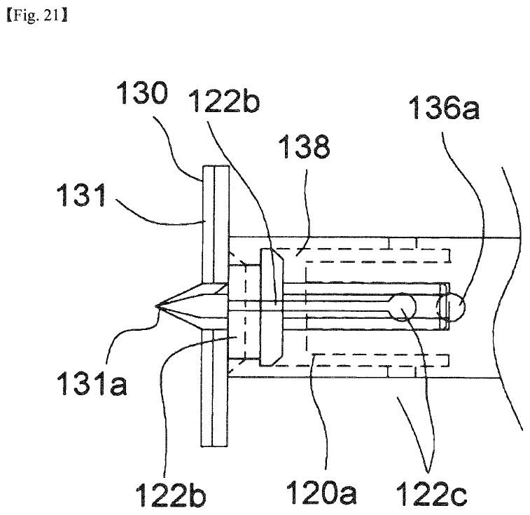

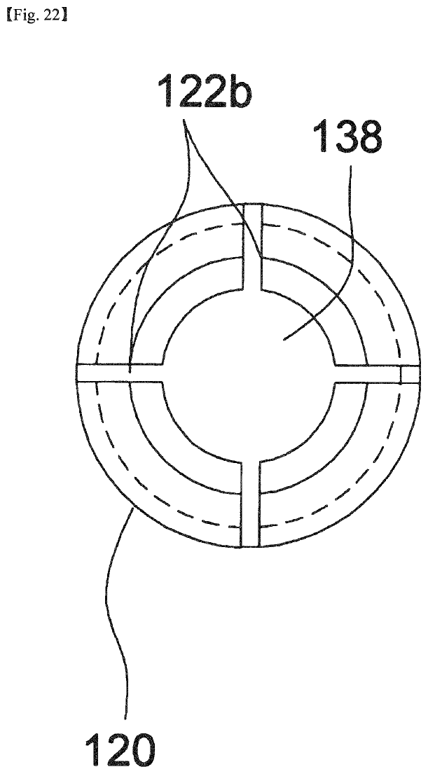

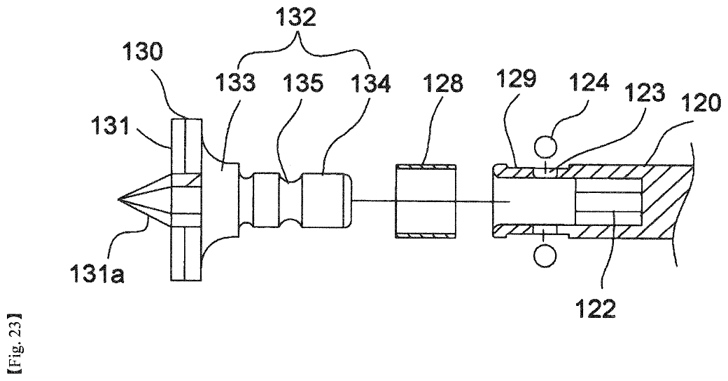

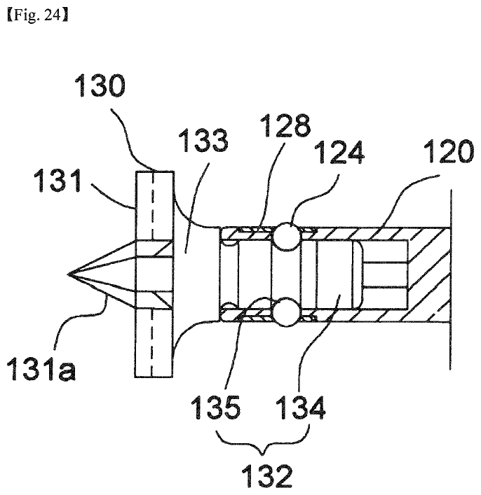

FIG. 1 is a perspective view illustrating a plant weeding device according to the present invention, FIG. 2 is a partially enlarged perspective view illustrating the plant weeding device according to the present invention, FIG. 3 is a partially enlarged perspective view illustrating another exemplary embodiment of the plant weeding device according to the present invention, FIG. 4 is a cross-sectional view illustrating a state before the plant weeding device according to the present invention operates, FIG. 5 is a cross-sectional view illustrating a state after the plant weeding device according to the present invention operates, FIG. 6 is a front view illustrating a state in which the plant weeding device according to the present invention operates, FIG. 7 is a front view illustrating a state in which a grasping means of the plant weeding device according to the present invention penetrates into the soil, FIG. 8 is a front view illustrating a state in which a cutting edge of the plant weeding device according to the present invention is used to remove weeds from plants, FIGS. 9 to 11 are cross-sectional views illustrating states in which a rod and a holder of a plant weeding device according to a first exemplary embodiment of the present invention are coupled, FIGS. 12 and 13 are cross-sectional views illustrating states in which the rod and a weeding blade of the plant weeding device according to the first exemplary embodiment of the present invention ar coupled, FIGS. 14 and 15 are schematic views illustrating states in which the rod and the weeding blade of the plant weeding device according to the first exemplary embodiment of the present invention are coupled, FIGS. 16 and 17 are cross-sectional views illustrating states in which a rod and a weeding blade of a plant weeding device according to a second exemplary embodiment of the present invention are coupled, FIGS. 18 and 19 are cross-sectional views illustrating states in which a rod and a weeding blade of a plant weeding device according to a third exemplary embodiment of the present invention are coupled, FIGS. 20 to 22 are cross-sectional views illustrating states in which a rod and a weeding blade of a plant weeding device according to a fourth exemplary embodiment of the present invention are coupled, and FIGS. 23 and 24 are cross-sectional views illustrating states in which a rod and a weeding blade of a plant weeding device according to a fifth exemplary embodiment of the present invention are coupled.

First, as illustrated in FIGS. 1 to 8, a plant weeding device 100 according to the present invention includes a housing 110, a rod 120, a weeding blade 130, and a power means 140.

The housing 110 is formed in a cylindrical shape having a length and has a coupling hole 111 penetrating a center of an inner portion of the housing.

The rod 120 penetrates the coupling hole 111 in the housing 110.

Further, a first stepped member 113 and a cover 116 are coupled to one side of the coupling hole 111 in the housing 110.

The first stepped member 113 is coupled to an inner circumferential edge of the coupling hole 111 at one side of the coupling hole 111, and a set screw 114 is fastened to the first stepped member 113 from the outside of the housing 110 by a tool.

In this case, the set screw 114 presses an outer circumferential edge of the rod 120, such that the first stepped member 113 is fixed to the rod 120 so that the first stepped member 113 and the rod 120 are cooperatively coupled.

Further, the cover 116 adjoins the first stepped member 113 and is coupled to seal one side of the coupling hole 111.

Further, a second stepped member 115 is coupled to the other side of the coupling hole 111, and the rod 120 penetrates the second stepped member 115.

The first stepped member 113 and the second stepped member 115 serve to support the rod 120 so that the rod 120 may be maintained in a vertical state at a center of the coupling hole 111.

In this case, an elastic member 112 is interposed between the first stepped member 113 and the second stepped member 115 installed in the coupling hole 111, and the elastic member 112 is installed on the outer circumferential edge of the rod 120 that penetrates the coupling hole 111.

Specifically, the rod 120 penetrates the coupling hole and may resiliently move and rotate.

The rod 120 may move forward or rearward toward a front or rear side of the housing 110.

In this case, when the rod 120 moves forward or rearward, the first stepped member 113 operates in conjunction with the movement of the rod 120 and compresses the elastic member 112 between the first stepped member 113 and the second stepped member 115, thereby enabling the rod 120 to move resiliently.

The weeding blade 130 is coupled to one end of the rod 120 and cooperatively rotates to dig up the soil, thereby removing weeds from plants.

The weeding blade 130 is formed in the form of a circular plate and equally divided to form a plurality of cutting surfaces 131 each having an edge.

Because the cutting surface 131 is formed to have the edge having a pointy line, the cutting surface 131 may easily dig up the soil while rotating when the cutting surface 131 compresses the soil while being rotated by the rod 120.

In this case, the weeding blade 130 is rotated by the power means 140, and the power means 140 may be coupled to or separated from the other end of the rod 120 and may rotate the rod 120.

In this case, a portable drilling machine commonly existing at home or industrial sites may be applied as the power means 140.

In this case, one surface of the rod 120 has a flat connecting surface 121 that may be connected to a socket installed on the drilling machine, such that rotational force of the drilling machine may be transmitted to the rod 120 without idling.

Resistive force is generated when a cutting edge digs up the soil, and an operator requires a large amount of supporting force if the resistive force is transmitted to the rod 120 and a drive means.

In order to prevent this, a plurality of grasping means 150 is installed around one end of the housing 110 so as to penetrate into the soil.

That is, the plant to be weeded is received in the plurality of grasping means 150, and the plurality of grasping means 150 is pressed to penetrate into the soil.

Thereafter, even though the resistive force is generated as the cutting edge is rotated by the drive means and digs up the soil, the cutting edge may be supported without swaying because the grasping means 150 penetrate into the soil, such that effective weeding efficiency of the cutting edge is improved.

In this case, the grasping means 150 are formed in an enlarged shape having a large diameter so that variously sized plants to be weeded are received in the plurality of grasping means 150.

That is, the grasping means 150 has a bent portion 151 bent outward at a predetermined angle, and a penetration portion 152 integrally extending from the bent portion 151 and having a pointy tip.

Therefore, the penetration portion 152 may more easily penetrate into the soil, and the plants to be weeded may be received in the grasping means 150.

Therefore, even the roots of the weeds in the soil are removed so that the weeds are completely removed, thereby improving weed removing efficiency.

In addition, the plant weeding device has a small volume and weight and thus is easy to carry and store, thereby enabling the user to simply remove, while standing, weeds inhabiting in grassplots such as weekend farms, gardens of rural houses, lawns, parks, playgrounds, golf courses, graveyards, and the like. Further, the plant weeding device cuts the roots without pulling out or digging up the roots and thus has an advantage in that it is not necessary to collect residues after removing the weeds.

In addition, rotational force is provided to the weeding device in order to enable the power means to be attached and detached, and a drilling machine commonly existing at home or industrial sites may be used as the power means, thereby providing convenience of use.

In addition, even though the resistive force is generated as the cutting edge is rotated by the drive means and digs up the soil, the cutting edge may be supported without swaying because the grasping means penetrate into the soil, such that effective weeding efficiency of the cutting edge is improved.

The rod 120 and the weeding blade 130 may be coupled in one-touch manner.

There are three exemplary embodiments.

First, as illustrated in FIGS. 9 to 15, a configuration of a first exemplary embodiment is as follows.

An installation hole 122 is formed at an end of the rod 120, and fixing balls 124 are received in mounting holes 123 formed at the outer circumferential edge of the rod 120, such that the fixing balls 124 are selectively and partially exposed to the inside of the installation hole 122.

Further, a holder 160 is provided to be movably coupled to the outer circumferential edge of the rod 120, and the holder 160 may be resiliently moved by a spring 161 installed in the holder 160.

A state in which the fixing balls 124 are exposed to the installation hole 122 through an introduction hole 162 having multiple steps having different diameters at an inner circumferential edge of the holder 160 is determined depending on a state in which the holder 160 moves. When an end protruding from the weeding blade 130 is coupled into the installation hole 122, the fixing balls 124 are received in an inwardly recessed groove 135 formed at the outer circumferential edge of the end 132, and the fixing balls 124 are received in a portion of the introduction hole 162 having the multiple steps, which has a relatively small diameter, thereby fixing the rod 120 and the weeding blade 130.

When the holder 160 moves while compressing the spring 161, the fixing balls 124 are moved to a portion of the introduction hole 162, which has a relatively large diameter, and the fixing balls 124 are withdrawn from the inwardly recessed groove 135 at the end, such that the weeding blade 130 is uncoupled from the rod 120.

In other words, a method of coupling and separating the rod 120 and the weeding blade 130 by using the above-mentioned configuration will be described below.

First, the method of coupling the rod 120 and the weeding blade 130 moves the holder 160 forward in order to couple the weeding blade 130 to the rod 120.

When the fixing balls 124 are moved to the portion of the introduction hole 162, which has a relatively large diameter, interference in the installation hole 122 is eliminated, such that the end of the weeding blade 130 is coupled into the installation hole 122.

Thereafter, when the user takes his/her hand off the holder 160 that has been moved rearward, the holder 160 is moved to an original position by restoring force of the spring 161.

In this case, the spring 161, which has been compressed between a first catching projection 163 of the holder 160 and a second catching projection 127 of the rod 120, is restored to an original state, thereby returning the holder 160 back to the original position.

As described above, the fixing balls 124 are moved inward from the large diameter portion to the small diameter portion of the introduction hole 162 by the movement of the holder 160, and a half of each of the fixing balls 124 is coupled into the inwardly recessed groove 135 formed at the end of the weeding blade 130, thereby maintaining the mutually coupled state.

On the contrary, when the holder 160 is moved in order to separate the weeding blade 130 from the rod 120, the fixing balls 124, which are coupled between the inwardly recessed groove 135 and the portion of the introduction hole 162 which has a small diameter, are moved to the portion of the introduction hole 162 which has a large diameter, such that the weeding blade 130 is uncoupled from the rod 120, and the rod 120 and the weeding blade 130 may be in a separated state.

In this case, the inner circumferential edge of the installation hole 122 and the outer circumferential edge of the end 132 have the same hexagonal shape, thereby preventing idling.

As illustrated in FIGS. 16 and 17, according to a second exemplary embodiment, an installation hole is formed at an end of the rod, and a recess is formed at an inlet end of the installation hole and receives fixing balls supported by a snap ring.

The end protruding from the weeding blade is coupled into the installation hole, the fixing balls are partially received in the inwardly recessed groove formed at the outer circumferential edge of the end, and the received state is maintained by the snap ring, thereby securing the coupled state between the rod and the weeding blade.

In this case, the fixing ball 124 applied to the second exemplary embodiment has a ball type cross section and has a partially cut out annular shape.

Therefore, an inner diameter of the fixing ball 124 is changed by elastic force of the snap ring 126, and the fixing ball 124 is installed to be separated or coupled by being resiliently inserted into the inwardly recessed groove 135 of the weeding blade 130.

As illustrated in FIGS. 18 and 19, according to a third exemplary embodiment, an installation hole 122 and a communication hole 136 are formed at an end of the rod 120 so as to form multiple steps having different diameters, and a connecting hole 138 is formed at the outer circumferential edge of the rod 120 while traversing the communication hole 136.

When a first end 133 and a second end 134, which protrude from the weeding blade 130 and have multiple steps therebetween, are coupled to the installation hole 122 and the communication hole 136, a catching hole 139 formed at the second end 134 and the connecting hole 138 communicate with each other, and a catching member 137 is coupled to couple the weeding blade 130 to the rod 120.

That is, with the catching structure using the catching member 137, the rod 120 and the weeding blade 130 may be coupled to or separated from each other.

In addition, a binding groove 129 is formed in an inlet of the connecting hole 138, and a binding means 128, which has a partially opened annular shape and resiliently changes in diameter, is coupled to the binding groove 129 after the catching member 137 is coupled to the connecting hole 138, thereby preventing the catching member 137 from being withdrawn to the outside.

As described above, the rod and the weeding blade may be coupled or separated in one-touch manner and thus easily replaced, thereby improving maintenance characteristics and operational characteristics of the weeding device.

As illustrated in FIGS. 20 to 22, a state in which a rod and a weeding blade of a plant weeding device according to a fourth exemplary embodiment of the present invention am coupled will be described below.

An inlet hole 122d and a catching groove 122a are formed at one end of the rod 120 so as to communicate with each other and have multiple steps therebetween, and a communication hole 136 is formed in the rod 120 so as to communicate with the catching groove 122a.

Further, a plurality of cut-out holes 122b is formed at the outer circumferential edge of the rod 120 and disposed at an equal interval so as to communicate with the communication hole 136 so that the catching groove 122a is resiliently enlarged, such that a catching end 133a, which is formed integrally with the weeding blade 130 through the first end 133, is coupled to the catching groove 122a through the inlet hole 122d in a catching manner.

Further, an installation hole 122 is formed in a protruding portion 120a formed on a bottom surface of the installation hole 122 so that a second end 134 formed at a rear side of the catching end 133a of the weeding blade 130 is coupled to the installation hole 122.

Further, enlargement holes 122c are formed at ends of the cut-out holes 122b, and a withdrawal hole 136a is formed at an outer circumferential edge of the protruding portion 120a so as to communicate with the bottom surface of the installation hole 122, such that the second end 134 of the weeding blade 130 is exposed through the withdrawal hole 136a. Therefore, the weeding blade 130 may be separated from the installation hole 122 by inserting a pointy tool into the withdrawal hole 136a.

As described above, when the weeding blade 130 is pressed, the second end 134 is inserted into the installation hole 122, such that the weeding blade 130 is coupled with a mutual hexagonal combination in order to prevent idling.

Further, when the catching end 133a is press-fitted into the inlet hole 122d and the catching groove 122a, the catching groove 122a is enlarged through the cut-out holes 122b, such that the catching end 133a is coupled to the lower end of the catching groove 122a in a catching manner.

As illustrated in FIGS. 23 and 24, a state in which a rod and a weeding blade of a plant weeding device according to a fifth exemplary embodiment of the present invention are coupled will be described below.

An installation hole 122 is formed at an end of the rod 120, mounting holes 123 are formed at the outer circumferential edge of the rod 120, fixing balls 124 are inserted into the mounting holes 123, and a first end 133, an inwardly recessed groove 135, and a second end 134 are sequentially formed on the weeding blade 130. The inwardly recessed groove 135 having a semicircular shape communicates with the mounting holes 123, the fixing balls 124 are coupled to the inwardly recessed groove 135 to maintain the coupled state between the weeding blade 130 and the rod, and the second end 134 is coupled to the installation hole 122 in order to prevent idling. A binding means 128 is coupled to a binding groove 129 formed at the outer circumferential edge of the rod 120 in order to prevent the fixing balls 124 from being withdrawn from the mounting holes 123.

As a result, the coupled state between the weeding blade 130 and the rod 120 is maintained by the fixing balls 124. When the fixing balls 124 are separated from the mounting holes 123 by separating the binding means 128 for preventing the withdrawal of the fixing balls 124, the weeding blade 130 and the rod 120 may be separated from each other.

1. A plant weeding device comprising:
a housing having a coupling hole penetrating a center of the housing;
a rod penetrating the coupling hole and configured to be resiliently movable and rotatable;
a weeding blade coupled to one end of the rod and configured to cooperatively rotate and dig up the soil to remove weeds from plants;
a power means configured to be coupled to or separated from the other end of the rod and configured to rotate the rod; and
a grasping means installed around one end of the housing and configured to penetrate into the soil to support the rotation of the weeding blade.

2. The plant weeding device of claim 1, wherein an elastic member is installed at an outer circumferential edge of the rod penetrating the coupling hole in the housing, the elastic member is installed between a first stepped member installed at one side of the coupling hole and a second stepped member installed at the other side of the coupling hole, and the elastic member is compressed by the first stepped member that operates in conjunction with the movement of the rod.

3. The plant weeding device of claim 1, wherein an installation hole is formed at an end of the rod, and a fixing ball is received in a mounting hole formed at an outer circumferential edge of the rod, such that the fixing ball is selectively and partially exposed to the inside of the installation hole,
wherein a holder is provided to be movably coupled to an outer circumferential edge of the rod, and the holder is resiliently moved by a spring installed in the holder,
wherein a state in which the fixing ball is exposed to the installation hole through an introduction hole having multiple steps having different diameters at an inner circumferential edge of the holder is determined depending on a state in which the holder moves,
wherein when an end protruding from the weeding blade is coupled into the installation hole, the fixing ball is received in an inwardly recessed groove formed at an outer circumferential edge of the end, and the fixing ball is received in a portion of the introduction hole having the multiple steps, which has a relatively small diameter, in order to secure a coupled state between the rod and the weeding blade, and
wherein when the holder moves while compressing the spring, the fixing ball is moved to a portion of the introduction hole, which has a relatively large diameter, and the fixing ball is withdrawn from an inwardly recessed groove at the end, such that the weeding blade is uncoupled from the rod.

4. The plant weeding device of claim 1, wherein an installation hole is formed at an end of the rod, and a recess is formed at an inlet end of the installation hole and receives a fixing ball supported by a snap ring,
wherein a second end at an end protruding from the weeding blade is coupled into the installation hole, and the fixing ball is partially received in an inwardly recessed groove formed at an outer circumferential edge of the end, and
wherein the received state is maintained by the snap ring in order to secure a coupled state between the rod and the weeding blade.

5. The plant weeding device of claim 1, wherein an installation hole and a communication hole are formed at an end of the rod so as to form multiple steps having different diameters, and a connecting hole is formed at an outer circumferential edge of the rod while traversing the communication hole, and
wherein when a first end and a second end, which protrude from the weeding blade and have multiple steps therebetween, are coupled to the installation hole and the communication hole, a catching hole formed at the second end and the connecting hole communicate with each other, and a catching member is coupled to couple the weeding blade to the rod.

6. The plant weeding device of claim 1, wherein an inlet hole and a catching groove are formed at one end of the rod so as to communicate with each other and have multiple steps therebetween, and a communication hole is formed in the rod so as to communicate with the catching groove,
wherein a plurality of cut-out holes is formed at an outer circumferential edge of the rod and disposed at an equal interval so as to communicate with the communication hole so that the catching groove is resiliently enlarged, such that a catching end, which is formed integrally with the weeding blade through a first end, is coupled to the catching groove through the inlet hole in a catching manner,
wherein an installation hole is formed in a protruding portion formed on a bottom surface of the installation hole so that a second end formed at a rear side of the catching end of the weeding blade is coupled to the installation hole,
wherein enlargement holes are formed at ends of the cut-out holes, a withdrawal hole is formed at an outer circumferential edge of the protruding portion so as to communicate with the bottom surface of the installation hole, such that the second end of the weeding blade is exposed through the withdrawal hole, and
wherein the weeding blade is separated from the installation hole by inserting a pointy tool into the withdrawal hole.

7. The plant weeding device of claim 1, wherein an installation hole is formed at an end of the rod, a mounting hole is formed at an outer circumferential edge of the rod, and a fixing ball is inserted into the mounting hole,
wherein a first end, an inwardly recessed groove, and a second end are sequentially formed on the weeding blade,
wherein the inwardly recessed groove having a semicircular shape communicates with the mounting hole, the fixing ball is coupled to the inwardly recessed groove to maintain a coupled state between the weeding blade and the rod, and the second end is coupled to the installation hole in order to prevent idling, and
wherein a binding means is coupled to a binding groove formed at the outer circumferential edge of the rod in order to prevent the fixing ball from being withdrawn from the mounting hole.
